(19) United States
(12) Patent Application Publication
(10) Pub. No.: US 2010/0239470 A1
(43) Pub. Date: Sep. 23, 2010

(54) Photocatalysts Based on Structured Three-Dimensional Carbon or Carbon-Containing Material Forms

(75) Inventors: Cuong Pham-Huu, Saverne (FR); Nicolas Keller, Strasbourg (FR); Marc-Jacques Ledoux, Strasbourg (FR); Valérie Keller-Spitzer, Oberschaeffolsheim (FR); Dominique Begin, Achenheim (FR); Pierre Bernhardt, Heiligenberg (FR); Sébastien Josset, Strasbourg (FR); Shabnam Hajesmaili, Strasbourg (FR); Thierry Romero, Strasbourg (FR); Nathanaëlle Wurtz, Creutzwald (FR)

Correspondence Address: REMENICK PLLC, 1025 THOMAS JEFFERSON STREET, NW, WASHINGTON, DC, 20007, US

(73) Assignees: Centre National de la Recherche; Scientifique

(21) Appl. No.: 12/559,070

(22) Filed: Sep. 14, 2009

Related U.S. Application Data
(60) Provisional application No. 61/112,998, filed on Nov. 10, 2008.

(30) Foreign Application Priority Data
Sep. 12, 2008 (FR) 0805023

(51) Int. Cl. B01J 19/08; B01J 21/18

(52) U.S. Cl. 422/186; 502/180; 502/182

(57) ABSTRACT

The invention relates to a photocatalyst comprising a cellular foam selected from carbon foam and the foam of a carbon material, such as a polymer, and a photocatalytically active phase, deposited directly on said cellular foam or on an intermediate phase deposited on said cellular foam. The average size of the cells is between 2500 μm and 5000 μm. The foam can comprise nanotubes or nanofibers (in particular TiO₂).

### TECHNICAL FIELD OF THE INVENTION

The invention relates to photocatalysts based on structured three-dimensional foams, in particular based on cellular carbon foams, process for producing them as well as process for using them in order to catalyze chemical reactions or the destruction of microbes, in particular for the purpose of decontaminating liquid or gaseous effluents.

### PRIOR ART

Photocatalysis enables valuable chemical reactions, stimulated by light in the presence of a photocatalyst. One of the problems presented by this approach is the design of the reactor, which must allow for a large exchange surface between the reaction medium and the catalyst, low head losses in the case of continuous reactors, and high light transmission. One problem involves arranging a large illuminated exchange surface between the photocatalyst and the reaction medium.

When substrates based on paper or non-woven fabric, for example, are used, it is not possible to work with a cross-flow with large substrate thicknesses, because the head losses would be too great. To have sufficient contact between the reaction medium and the photocatalytically active phase, either large paper surfaces are used to obtain a sufficient catalytic effect (see U.S. Pat. No. 6,906,001 (Ahlstrom Research and Services) which proposes applying the photocatalyst to suspended ceiling panels of living spaces), or, and in particular for chemical engineering applications, it is necessary to work with a skimming flow.

We therefore searched for porous or structured substrates in order to increase their surface.

As an example, the patent application WO 03/037509 (SICAT, CNRS and Université Louis Pasteur) describes a process for purifying gaseous effluents using a porous photocatalyst including SiC, TiO₂ and WO₃.

The patent application WO 2006/061518 (CNRS and Université Louis Pasteur) describes a process for inactivating biological agents dispersed in a gaseous medium by a photoactivated semiconductor based on TiO₂ deposited on the internal surface of a reactor; this reactor has, at the interior, projections so as to increase its internal surface.

The article “Influence of the geometry of a monolithic support on the efficiency of photocatalyst for air cleaning” by M. Furman et al. (Chemical Engineering Science vol. 62, p. 5312-5316 (2007)) presents a model study of a photocatalytic reactor with a porous support. The epoxy resin support was prepared by stereolithography and TiO2 was deposited as a photocatalyst.

The use of photocatalysts in the form of a foam, or deposited on a support in the form of a foam, is known. In particular, photocatalysts based on a TiO₂ foam, or TiO₂ catalysts deposited on a support in the form of a foam, in particular nickel and alumina, have been used. The articles “Preparation of titania foams having an open cellular structure and their application to Photocatalysis” by A. Yamamoto and H. Imai (Journal of Catalysis, vol. 226, pages 462-465 (2004)) and “The design and photoreaction kinetic modeling of a gas-phase titania foam packed bed reactor” by A. O. Ibhadon (Chemical Engineering Journal vol. 133, p. 317-323 (2007)) describe the preparation of a TiO₂ foam and the photocatalytic use thereof to degrade acetaldehyde and benzene or toluene, respectively.

The article “Design considerations of photocatalytic oxidation reactors using TiO₂-coating foam nickels for degrading indoor gaseous formaldehyde” by L. Yang et al. (Catalysis Today vol. 126, p. 359-368 (2007)) describes a reactor comprising a thin layer of TiO₂, with an optimal thickness of 80 nm (for an excitation wavelength of 254 nm), deposited on a nickel foam; the thickness of the nickel foam is limited to around 2 mm due to its optical absorption.

The article “Three-phase Photocatalysis using suspended titania and titania supported on a reticulated foam monolith for water purification” by I. J. Ochuma et al. (Catalysis Today, vol. 128, p. 100-107 (2007)) describes the use of a photocatalyst based on TiO₂, deposited by vaporization of a TiO₂ suspension on an alumina foam, in order to degrade DBU (1,8-diazabicyclo[5,4,0]undec-7-ene contained in an aqueous effluent. The article “Potential of Silver Nanoparticle-Coated Polyurethane Foam as an Antibacterial Water Filter” by Prashant Jain and T. Pradeep, published on 5 Apr. 2005 in the journal Biotechnology and Bioengineering, vol. 90 (1), p. 59-62, describes the attachment of silver nanoparticles on a polyurethane foam support.

The article “Carbon foams prepared from polyimide using polyurethane foam template” by Inagaki et al., published in the journal Carbon 42, pages 497-502 (2004) describes the deposition of anatase on carbon foams with small macropores, with a diameter of around 50 μm to 500 μm. The data on the efficacy of such a catalyst is rudimentary. Document US 2008/0178738 (Foamex L.P.) describes the deposition of anatase on a polyurethane form of unknown porosity.

β-SiC foams, which can serve as a catalyst support, are also known. The patent application WO 2007/000506 (TOTAL S.A.) describes a process for transforming carbon monoxide and hydrogen into hydrocarbons according to the Fischer-Tropsch reaction, in which a β-SiC cellular foam is used as a catalyst support.

Metal foams are also known, and can be used as a catalyst support, but, aside from their high price and weight, they can present corrosion problems.

The problem that this invention is intended to solve is that of providing a new photocatalyst for heterogeneous catalysis, with low head losses and a large developed specific surface, and having good chemical inertia.

### FIGURES

FIGS. 1 to 5 relate to embodiments of the invention.

FIG. 1 shows the micrograph obtained by scanning electron microscopy of a polysiloxane deposit on a polyurethane cellular foam by depositing an aqueous sol-gel of modified silica, according to an embodiment of the invention.

FIG. 2 shows micrographs obtained by scanning electron microscopy of TiO₂ deposits obtained by the successive deposition of individual layers on carbon foam: deposition of 5 layers (FIG. 2A), 10 layers (FIG. 2B) and 15 layers (FIG. 2C).

FIGS. 3 to 5 show embodiments of a cylindrical reactor according to the invention. In this reactor, the catalyst support is assembled from cylindrical cellular foam rings according to the invention.

FIG. 3 diagrammatically shows the inside of a tubular reactor comprising a cellular foam assembled from identical (a) or alternatively differently-shaped (b) cylindrical rings.

FIG. 4 shows the sides of the cylindrical rings of these reactors, as well as a particle speed profile.

FIG. 5 shows an example of a reactor having a structured configuration in alternation with 8 equidistant foam elements.

### OBJECTIVES OF THE INVENTION

According to the invention, the problem is solved by a photocatalyst comprising a cellular foam selected from carbon foam and the foam of a carbon material, such as a polymer, and a photocatalytically active phase, deposited directly on said cellular foam or on an intermediate phase deposited on said cellular foam. The average size of the cells is between 2500 μm and 5000 μm, and preferably between 3000 μm and 5000 μm. The density thereof is advantageously between 0.1 g/cm³ and 0.4 g/cm³. The photocatalyst according to the invention can have, in the visible spectrum between 400 and 700 nm, an overall optical transmission of at least 10% for a foam with a thickness of 1.5 cm, and preferably at least 15%. Said foam can comprise a passivation layer capable of protecting it from the reaction medium of the photocatalytic reactor and from degradation or oxidation resulting directly from the presence of the photocatalyst. Said foam can comprise nanotubes or nanofibers, which constitute, or which support as an intermediate phase, the photocatalytically active phase. Said nanotubes or nanofibers are preferably selected from TiO₂ and titanates. The external diameter of these nanotubes or nanofibers can be between 10 nm and 1000 nm, preferably between 10 nm and 160 nm, and even more preferably between 10 nm and 80 nm.

The photocatalytically active phase must be a semiconductor, and can be a chalcogenide (such as an oxide, sulfide or selenide). More specifically, it can be selected from the group consisting of: metal oxides such as WO₃, ZnO, TiO₂ and SnO₂; titanates, metal sulfides or selenides, optionally doped, such as CdS, CdSe, ZnS, ZnSe and WS₂; type III-V semiconductors, optionally doped, such as GaAs and GaP; and SiC. The semiconductor can be doped, modified at its surface or in its volume, or coupled with other materials that are advantageously semiconductors.

Another objective of the invention is a process for producing a photocatalyst based on carbon cellular foam, including the following steps:

(a) a carbonizable cellular polymer foam preform is provided;

(b) said preform is impregnated with a carbonizable polymer resin;

(c) said polymer resin is polymerized;

(d) said preform and said polymerized resin are transformed into carbon;

(e) a photocatalytically active phase is deposited, preferably selected from the semiconductors in the group consisting of:
metal oxides such as WO₃, ZnO, TiO₂ and SnO₂,
titanates,
metal sulfides or selenides, such as CdS, CdSe, ZnS, ZnSe and WS₂,
type III-V semiconductors, such as GaAs and GaP,
SiC,

in which these photocatalytically active phases are optionally doped or grafted with charge transfer elements such as chromophores and/or nanoparticles (“quantum dots”), and/or a second semiconductor material absorbing in the visible or ultraviolet (UV) spectrum and capable of transferring the charge to the first semiconductor or the reverse.

Between steps (d) and (e), it is possible to deposit nanotubes or nanofibers, preferably of TiO₂ or titanate, in which the deposition of said TiO₂ nanofibers or nanotubes can optionally replace the deposition of the photocatalyst in step (e).

The photocatalytically active phase can be deposited, for example, by one of the following techniques:
from a suspension of crystallized particles, preferably applied by soaking and impregnation, aerosol or droplets,
by sol-gel synthesis,
by deposition from a vapor phase,
by deposition of successive polyelectrolyte layers,
by the Langmuir-Blodgett technique.

The invention also relates to a photoreactor comprising at least one photocatalyst according to the invention. This photocatalyst advantageously includes a liquid- and gas-tight casing, at least one part of a photocatalyst according to the invention inside said casing, and at least one light radiation source. Said at least one photocatalyst part can have a ring shape.

In one embodiment, said photoreactor includes a plurality of N annular parts of a photocatalyst according to the invention, and said light radiation is introduced in the internal diameter of said annular parts, and said annular parts have an internal diameter that is alternatively different, so that all of the even-numbered parts have the same internal diameter d₁, and all of the odd-numbered parts have the same internal diameter d₂. Said annular parts can be separated by an empty space or a part that is optically transparent to at least a portion of said light radiation used.

The invention also relates to such a photocatalyst according to the invention or such a photoreactor according to the invention for catalyzing liquid-phase chemical reactions.

Finally, the invention relates to the use of such a photocatalyst according to the invention or such a photoreactor according to the invention for inactivation or degradation of biological agents.

### DESCRIPTION

In general, in this document, the term “specific developed surface” refers to the ratio between the developed surface (m²) and the occupied volume (m³): this parameter defines the surface exposed to the flow per unit of volume. The volume occupied is defined by the outer sides of the part, as if it were solid.

The “porosity” of a material is normally defined by reference to three categories of pores that are distinguished by their size: the microporosity (diameter lower than around 2 nm), mesoporosity (diameter between around 2 and around 50 nm) and macroporosity (diameter greater than around 50 nm).

The term “cellular foam” refers to a foam with an open porosity having both a very low density and a very high porous volume. The size of the pore openings is variable. Such a foam has a very low microporosity. The mesoporosity is essentially related to the bridges that form cells. The open macroporosity of such a foam can vary from 30 to 95%, in particular 50 to 90%, and its volume density can be between 0.05 g/cm³ and 0.5 g/cm³. In general, for its use as a catalyst support or a catalyst, below a density of 0.05 g/cm³, problems of mechanical strength of the foam arise, while above 0.5 g/cm³, the porous cellular volume will be reduced and the head losses will increase without providing any functional advantage. Advantageously, the density is between 0.1 and 0.4 g/cm³.

According to the general acceptance of the term “foam”, it is not necessarily cellular. In this more general sense of the term “foam”, it can also simply comprise bubbles (as in metal foams or cement foams obtained by adding aluminum powders, which, by reacting with the liquid cement, form gas bubbles). Such a foam is not cellular.

In general, porous cellular foams are described by four main characteristic quantities: the size of the windows (Phi), the size of the cells (a), the size of the bridges (ds) and the porosity (epsilon); the porosity (epsilon) is equal to 1−Vₛ/V_{foam}, in which V_{foam} represents the volume macroscopically occupied by the foam (this volume is defined by the sides of the foam part, as if it were a solid part), and Vₛ represents the volume of material constituting the foam part.

These four parameters are often associated in pairs: for example: phi/a=f(epsilon), or ds/a=f(epsilon.)

In general, in this document, by “carbon material”, we mean any organic, natural or synthetic material, such as: carbon chain-based polymers, which can comprise heteroatoms in the chain or as substituents; materials obtained by partial degradation (thermal, for example) of carbon chain-based polymers. In this sense, carbides and pure carbon (obtained, for example, by total pyrolysis of carbon materials) are not covered by the term “carbon materials”.

In general, in this document, by “biological agents”, we mean biological entities, generally small, typically between 0.01 μm and 10 μm, and capable of being transported by a gaseous or liquid current. Thus, the biological agents to be inactivated according to the process of the invention can in particular be bacteria (such as bacteria of the Legionella genus, for example Legionella pneumophila), viruses, fungal spores, bacterial spores or a mixture of these entities.

By “inactivated biological agent”, we mean a biological agent that has lost a biological activity, and in particular its capacity for replication or reproduction, or, in the case of a virus, its capacity for infection or contamination. Thus, inactivated bacteria is no longer capable of developing a colony after being cultured in a suitable medium, and an inactivated virus is no longer capable of being reproduced in a suitable cell.

According to the invention, the problem can be solved by using carbon, carbon material or carbide cellular foams, which have sufficient light transmittance, very low head losses and high porosity. According to the invention, the foams should an average cell size of between 2500 μm and 5000 μm; surprisingly, in spite of the large size of the cells, foams have a sufficient catalytic activity. Below 2500 μm, the optical transmission of the foams becomes too low for thick-layer applications (as required in most industrial reactions). Above 5000 μm, the conversion efficacy decreases considerably.

The fact that foams with such a large cell size provide good results is surprising, both with respect to porous ceramic monoliths and with respect to cellular foams having small cells. Indeed, in consideration of the hydrodynamic factors, the use of cellular foams with a large cell size in catalysis or filtration, and in particular in photocatalysis, does not in principle appear to be beneficial.

Indeed, according to the observations of the inventors, cellular foams are beneficial in terms of performance if their four main factors are appropriately modulated. In particular:
The specific surface developed by the cellular foams is an important factor. In this invention, it is preferable to have a developed surface of at least 100 m⁻¹ and preferably between 100 m⁻¹ and 3000 m⁻¹.
The filtration or impacting power of cellular foams is surprisingly important. We refer to filtration power for particles (therefore microorganisms: viruses, bacteria, spores, etc.) and impacting for chemical molecules. In general, four forces acting on this filtration or impacting power can be defined: Brownian movement, gravity, intersection forces, direct impaction forces.

The inventors have found that these forces have a greater impact for smaller bridge sizes (ds). The predominant forces dependent on: whether they are chemical molecules or microorganisms, and even whether it is a virus (for example, 40 nm in size) or bacteria (for example 1 μm×3 μm in size).
The gas-solid or liquid-solid material transfer is high. The inventors observed that, surprisingly, this material transfer improves for larger cell sizes.
The transmission of light in the foams must be high for photocatalysis applications.

Given that the various characteristic quantities are linked to one another, the gain in performance when using cellular foams in photocatalysis results in an optimization of these different parameters. This optimum is represented primarily by cellular foams of which the average cell size is between 2500 μm and 5000 μm, and more specifically between 3000 μm and 5000 μm.

Another advantage of carbon cellular foams with respect to porous ceramic monoliths is that each of the four parameters (i.e. the window size (Phi), the cell size (a), the bridge size (ds) and the porosity (epsilon)) is controllable (modulable), which is not the case for monoliths.

The foams according to the invention must have a sufficient optical transmission in the visible and near-UV spectrum in order to be used as a photocatalyst or a photocatalyst support. We prefer that the overall optical transmission be at least 10% for a thickness of 1.5 cm of cellular foam and for light with a wavelength of between 400 and 750 nm.

In general, for its use as a catalytic support or catalyst in the context of this invention, below a density of 0.05 g/cm³, problems of mechanical strength are encountered, while above 0.5 g/cm³, the cellular porous volume will be reduced and the head losses will increase, without any functional advantage. Advantageously, the density of the cellular foam used in the context of this invention is between 0.1 and 0.4 g/cm³.

The invention can be produced with different types of cellular foams.

### a) Carbon Cellular Foams

These foams can be prepared by impregnating a cellular preform made of polymer foam, preferably a polyurethane (PU) foam (such foams are available on the market) by mixing a formophenolic resin, followed by drying (typically at room temperature for one night), then polymerization of the resin by baking (typically at 150° C. for around 2 hours). Then, pyrolysis is carried out (typically at around 700° C. for around 2 hours under an inert gas flow, advantageously argon) in order to transform the foam from a cross-linked polymer into a carbon foam.

### b) Carbon Material Cellular Foams

In a preferred embodiment, a cellular preform made of polymer foam, for example PU, is impregnated with a silica precursor, such as a polysiloxane. After drying, a heat treatment is performed (typically at a temperature between 100° C. and 140° C.) in order to form a silica layer. A passivated polymer foam preform is thus obtained, on which a photocatalytically active phase can then be deposited. Such a foam can be suitable for applications not involving a high temperature. Its production is particularly simple because it does not involve a high-temperature process. As in the case of the other cellular foams according to this invention, the average cell size must be between 2500 μm and 5000 μm, and preferably between 3000 μm and 5000 μm.

Several precisions will be made here on the passivation of the polymer foam. By “passivation”, we mean the action of creating, according to a physical or chemical technique, a so-called “passivation layer” with a more or less high thickness enabling direct contact between the photocatalytically active phase and the polymer substrate to be avoided.

This passivation layer can be produced directly on the substrate, by performing a physical or chemical treatment of a passivation layer precursor previously deposited on the foam according to an appropriate technique (see example 5 and example 14, below). The passivation layer precursor can be deposited in liquid form on the substrate according to any suitable method, in particular in pure or diluted form, in the form of a mixture with a phase having a predetermined physicochemical role such as a binder, dispersant or fixative. It can be deposited in particular by immersion, followed by a low-temperature heat treatment. This treatment is called “low-temperature” because it differs from usual treatments on the order of 700° C. necessary for obtaining alumina in its allotropic gamma form, and which the PU foam cannot withstand.

This immersion/heat treatment sequence can be performed once or more than once according to the thickness of the layer to be obtained.

The heat treatment can be replaced by a microwave treatment, which enables shorter treatment times to be used than with conventional thermal heating.

According to another embodiment, this layer may be produced by a physical or chemical (post-synthesis) treatment of the passivation phase, previously synthesized, for example in the form of particles, then deposited on the substrate, in powder form or dispersed in a liquid phase, which can be a solvent such as water, ethanol or a phase having a predetermined physicochemical role such as a binder, dispersant or fixative. The physical or chemical treatment can in this case enable the deposition to be densified so as to thus form a continuous passivation layer at the surface of the substrate. The post-synthesis treatment can, depending on the case, consist simply of drying of the entire active foam phase, at or even below room temperature.

Owing to the sensitivity of PU cellular foams, it is recommended in various treatments not to remain at 200° C. for longer than 15 minutes, at 170° C. for longer than 2 hours, or at 150° C. for longer than 12 hours, so that these foams can satisfy their role in the photocatalysts according to the invention.

The passivation layer can be produced by using oxide phase precursors such as alumina, silica, zinc oxide, etc., according to the methods for obtaining these phases known to a person skilled in the art. As an example, it is possible to use, as a passivation layer precursor, the Dynasylan SIVO™ 110 polysiloxane sold by the Evonik company, or the Dynasylan HYDROSIL™ 1151 polysiloxane, also sold by the Evonik company.

In addition, the passivation layer can in particular be produced according to a sol-gel method, or any method enabling a sufficiently dense and continuous layer to be obtained in order to ensure its function of protection of the polymer cellular foam substrate.

The deposition of the photocatalytically active phase can be performed once the protective layer has been finalized, or the photocatalytically active phase can be incorporated in any step of the production of the protective layer.

### c) Deposition of Nanofibers or Nanotubes

This deposition is optional. Nanotubes or nanofibers can be deposited on the carbon cellular foam, according to techniques known to a person skilled in the art. For example, they can be deposited by techniques described below under d) (“first method”), also suitable for all types of nanotubes and nanofibers.

The deposition of titanate nanotubes can be done in the same way as the deposition of TiO₂ nanotubes described below under d) (“first method”), which is also suitable for all types of nanotubes and nanofibers. The titanate nanotubes are prepared by hydrothermal treatment (advantageously at a temperature of between 110 and 145° C., typically 130° C.) of a TiO₂ powder in a strong base (typically NaOH) concentrated (typically 10 M) in an autoclave. Then, they are washed, dried and calcined at a temperature between 350 and 450° C. (typically 380° C.) According to an embodiment, 1 g of TiO₂ powder is added to 50 mL of a NaOH solution (10 M) in a Teflon autoclave. The assembly is stirred for an hour, then left at 130° C. for 48 hours. The white powder obtained is then filtered under vacuum and washed with HCl (2 M) until neutral, rinsed in distilled water, then dried overnight at 110° C., and calcined at 380° C.

### d) Deposition of the Photocatalyst

The photocatalyst can be deposited directly on the cellular foam, passivated or not, or on an intermediate phase, in particular one-dimensional. Such an intermediate one-dimensional structure can be a structure on the nanometric scale, in the sense that at least one dimension of the object is limited to a nanometric size (in particular under the usual terms: nanofibers, nanotubes or nanowires, without being limited to those, independently of their chemical nature, even if such supports based on carbon or oxide are most popular).

It can also be a structure on the micronic scale, in the sense that at least one dimension of the object is limited to a micronic size (in particular under the usual terms: microfibers or fibers, without being limited to these, independently of their chemical nature; fibrous silica- or quartz-based supports are mentioned here as examples).

Advantageously, if an intermediate phase is used, the photocatalytically active phase is deposited on the nanotubes or nanofibers deposited as described above.

The photocatalytically active phase must comprise at least one semiconductor material in its chemical composition.

By semiconductor material, we mean, in the sense of this invention, a material in which the electronic states have a band spectrum including a valence band and a conduction band separated by a forbidden band, and where the energy necessary for passing an electron from said valence band to said conduction band is preferably between 1.5 eV and 4 eV. Such semiconductor materials can in particular include chalcogenides, and more specifically titanium oxide, or other metal oxides such as WO₃, ZnO or SnO₂, or metal sulfides such as CdS, ZnS or WS₂, or selenides such as CdSe, or other compounds such as GaAs, GaP or SiC. According to this invention, it is preferable to use titanium oxide TiO₂, which leads to particularly satisfactory results, and which is inexpensive.

In the sense of this description, the term “photoactivated semiconductor material” refers to a semiconductor material of the type mentioned above that has been subjected to radiation including energy photons with energy levels higher than or equal to that necessary to promote the electrons from the valence band to the conduction band (so-called gap energy between the valence and conduction bands).

Thus, in the sense of this description, we particularly mean by “photoactivated titanium oxide” a titanium oxide subjected to radiation including photons with energy levels higher than or equal to that necessary to promote the electrons from the valence band to the conduction band, typically radiation containing photons with energy above 3 eV, and preferably 3.2 eV, and in particular radiation including wavelengths below or equal to 400 nm, for example below or equal to 380 nm. It is also possible to use visible light, if it enables the semiconductor material to be activated. This is the case of TiO₂, in rutile form, for example. If necessary, for example, for anatase TiO₂, it is possible to graft charge transfer elements onto the semiconductor; these can be chromophores and/or nanoparticles (“quantum dots”), of a second semiconductor material absorbing in the visible spectrum and capable of transferring the charge onto the first semiconductor. As an example, it is possible to use CdS nanoparticles (with a size typically between 2 and 10 nm). Another possibility for using TiO₂ in anatase form is to modify it by doping; the anatase allows for better quantum efficiency than the rutile form.

As radiation, it is possible to cite in particular the radiation provided by ultraviolet radiation lamps of the so-called black light lamps, or that provided by light emitting diodes (LED).

It is known that, in a photoactivated semiconductor material, and in particular in a photoactivated titanium oxide, electron/hole pairs (a hole being a lack of an electron in the valence layer, left by a jump of an electron to the conduction band) are created under the effect of radiation of the type mentioned above, which confers pronounced oxidation-reduction properties on the photoactivated semiconductor material. These oxidation-reduction properties are particularly pronounced in the case of photoactivated titanium oxide, which are used to advantage in numerous photocatalytic applications of titanium oxide.

The deposition of photocatalytic particles on cellular foam can be a discontinuous deposition of isolated photocatalytic particles, or it can consist of a more or less uniform coating covering a significant portion, and even the majority or entirety of the surface. The deposition of the photocatalytically active phase can be performed directly on the cellular foam, or on an intermediate coating deposited on said foam, for example of nanofibers or nanotubes. The photocatalytic particles can be composed of a single semiconductor, or they can consist of a mixture of phases, of which at least one is photocatalytic. Advantageously, the photocatalytic particles are TiO₂ (titanium dioxide); these particles can be doped.

According to the invention, the deposition of the photocatalytically active phase can be performed by any suitable process. Below, we describe a plurality of deposition techniques, taking into account, as an example, a preferred active phase, TiO₂. It is understood that these techniques and processes can be adapted to other photocatalytically active phases, and in particular to other oxides and other chalcogenides.

According to a first method, crystallized particles are deposited, which are put in suspension in a suitable solvent, then they are spread on the substrate formed by the foam, for example by soaking the substrate. More specifically, the deposition can be obtained by impregnating the foam with a solution containing particles of the photocatalytically active phase in crystallized form, for example a chalcogenide (such as TiO₂). This impregnation is followed by drying in order to remove the solvent used in the impregnation.

According to a second method, the synthesis of TiO₂ can be performed directly on the foam, by impregnating it with a solution containing the TiO₂ precursor, according to a mode of synthesis called sol-gel synthesis. This process can be performed in different ways. In an advantageous embodiment, first, from a colloidal solution of an amorphous gel, essentially amorphous particles are deposited on the substrate formed by the foam, then it is dried and heated at a sufficient temperature and for a sufficient time to transform these amorphous particles into crystals. Any sol-gel method of which the implementation enables crystallized particles to be obtained may be suitable. The crystallization will be better at high temperature, but the temperature should not exceed 120 to 140° C. for the PU foam and 400 to 450° C. for the carbon foam.

In an advantageous embodiment of this method, the TiO₂ precursor is a titanium alkoxide, and preferably titanium isopropoxide. It will then be followed by a drying, then a calcination step, at a temperature not exceeding the values indicated above, in order to crystallize the material in its TiO₂ form. This sol-gel technique can be applied to other metal oxides.

According to a third method, the synthesis of TiO₂ can also be performed directly on foam from a vapor phase containing a gaseous TiO₂ precursor, by causing a gas stream containing said TiO₂ precursor to pass. This precursor can be, for example, a titanium alkoxide or a titanium chloride. This process can be assisted by plasma, or it can take place without plasma. It is then followed by a drying, then a calcination step in order to crystallize the material in its TiO₂ form. This technique can be applied to other photocatalytically active semiconductors.

According to a fourth technique (called LBL for Layer-By-Layer), successive layers of polyelectrolytes are deposited. This technique is described conceptually in the article “Fuzzy Nanoassemblies: Toward Layered Polymeric Multicomposites” by Gero Decher, published in the journal Science, vol. 277, p. 1232-1237 (1997)). Advantageously, at least eight layers are deposited.

According to a fifth technique, photocatalytically active phase particles (such as TiO₂) are deposited by the Langmuir-Blodgett method, described as such in the article “Preparation and Organized Assembly of Nanoparticulate TiO₂—Stearate Alternating Langmuir-Blodgett Films” by Lin Song Li et al, published in the Journal of Colloid and Interface Science, vol. 192, p. 275-280 (1997), in the article “Preparation of a TiO₂ Nanoparticular Film Using a Two-Dimensional Sol-Gel Process” by I. Moriguchi et al, published in the journal Chem. Mater., (1997), p. 1050-1057, and in the article “Characterization of TiO₂ Nanoparticles in Langmuir-Blodgett Films” by P. J. G. Coutinho, published in the Journal of Fluorescence (2006), p. 387-392.

The exact nature of the active phase used according to the invention to develop photocatalytic properties, insofar as it comprises at least one material activated by light radiation, is, as a general rule, not an influencing factor for producing a reaction or a carrying out a photocatalytic process.

Thus, in the case of titanium oxide, for example, any titanium oxide developing photocatalytic properties and capable of being anchored in the form of particles or a coating on the foam can be used effectively in the process of the invention, which constitutes another advantage of the process.

Nevertheless, according to an embodiment, the titanium oxide used according to the process of the invention contains anatase TiO₂, preferably in an amount of at least 50%. Thus, according to this embodiment, the titanium oxide used can, for example, essentially (i.e., in general, for at least 99% by weight, and preferably for at least 99.5% by weight) be made up of anatase TiO₂.

The use of rutile TiO₂ is also valuable, insofar as the TiO₂ in this form is photoactivated by the visible light spectrum.

According to another advantageous embodiment, the titanium oxide used includes a mixture of anatase TiO₂ and rutile TiO₂, preferably with an anatase/rutile weight proportion of between 50/50 and 99/1, for example between 70/30 and 90/10, and typically on the order of 80/20.

In addition, in particular to optimize the exchanges between the titanium oxide semiconductor material and the reaction flow, it is usually advantageous for the semiconductor material used to have a specific surface of between 2 and 500 m²/g, preferably greater than or equal to 20 m²/g, and even more advantageously at least equal to 50 m²/g, in particular when it is titanium oxide.

The photoactivated semiconductor material that is used according to the invention can be in various physical forms, depending on the medium treated, and in particular depending on the volume of this medium and the rate at which the process is to be implemented. In general, the titanium oxide semiconductor material can be used in any form suitable for its irradiation by radiation with a wavelength enabling its photoactivation and enabling the titanium oxide to be placed in contact in the photoactivated state with molecules of the reaction flow, on the condition that it is accessible.

### e) Use in Photocatalysis

A plurality of types of photocatalytic reactors can advantageously be used. It is possible to introduce one or more foam parts, for example with a cylindrical shape, in a casing element forming a liquid- and gas-tight wall, in which said casing element is transparent or not, through which the reaction medium passes. Said casing element can be a tubular element. In the case of a transparent casing element, the light can come from outside (i.e. by an external lamp), while in the case of an opaque casing element, the light must come from inside (for example, an internal lamp, or by LED diodes, or by quantum dot devices), or must be brought inside by optical fibers. A plurality of such casing elements, for example tubular elements, can be arranged in parallel, optionally using a common light source (in particular in the case of transparent tubes). It is also possible to use a multiple channel reactor, in which each channel consists of at least one tubular element, and the reactor is provided with solenoid valves enabling the reaction medium flow to be switched to at least one tubular element(s), and the other (or others) can be regenerated or exchanged while the other(s) are operating.

In another embodiment, a reactor, typically tubular, with a larger diameter, for example between 10 and 100 cm is used, in which one or more cylindrical foam parts, as well as a plurality of light sources are introduced; the latter are introduced in these foam parts, typically in the form of tubular lamps with an elongate shape (typically approximately cylindrical) or optical fibers oriented so as to be parallel in the lengthwise direction of said tubular element. The foam parts advantageously have a cylindrical shape; they can have a ring shape. In the same reactor, successive foam parts can include photocatalysts of a different type.

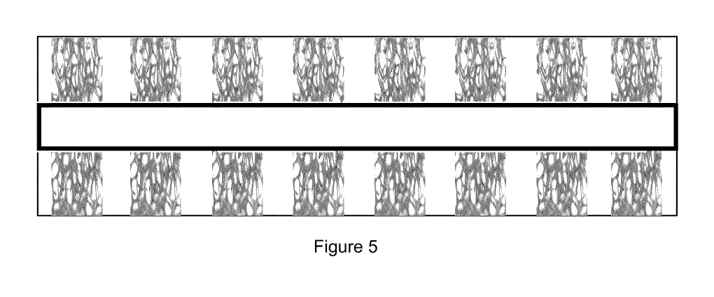

In an advantageous embodiment of a photocatalytic reactor according to the invention, foam rings having different alternating internal diameters are introduced into a tubular element. FIG. 4(a) diagrammatically shows this shape for a configuration comprising 13 cylindrical foam rings, alternatively 7 cm in external diameter and 2 cm in thickness; FIG. 5 shows the sides. At the center of the rings is a longitudinal light source. FIG. 4(b) shows, by way of comparison, a reactor with cylindrical foam rings of the same diameter. The speed profile in the two reactors was calculated for a gas or liquid flow; the result is provided in FIG. 5. It is thus noted that the speed profile of the particles is asymmetrical when the internal diameter of the rings is not the same (the case of FIG. 4(b)). It is due to this asymmetry that a larger part of the flow passes into the lighter areas: such a reactor has a higher conversion rate than a reactor of which the internal diameter is constant. A reactor filled with alternating foams can be preferred to the same reactor integrally filled with foam over the entire length thereof.

This enables the amount of light received at each point of the foam to be increased overall, which can, in the case of an appropriate choice of alternation of foams, compensate for the reduction in the amount of foam, and therefore the amount of photocatalytically active phase inside the reactor.

In an embodiment diagrammatically shown in FIG. 6, the space left available by the removal of a certain number of foams of the reactor is distributed over the entire reactor, so that the foams are equidistant inside the reactor. The equidistance is not, however, an absolute necessity.

The photocatalyst according to the invention is suitable for gaseous or liquid phase reactions, for reactions such as oxidation (for example oxidation of alcohol or oxidation of CO into CO₂), reduction, reforming, decomposition (for example of harmful volatile organic compounds (VOC)), hydrogenation and/or dehydrogenation of hydrocarbons or organic compounds, and photolysis of water or reforming of alcohols such as methanol. It is also suitable for partial oxidations of organic molecules. It is also suitable for oxidation of molecules containing heteroatoms such as sulfur, phosphorus and nitrogen. Among the sulfur molecules, we can cite diethyl sulfur, dimethyl sulfur, H₂S and SO₂. Among the phosphorus molecules, we can cite the organophosphorus molecules, such as dimethyl methylphosphonates. Among the nitrogen molecules, we can cite methylamines and acetonitrile. It is also suitable for reactions enabling a nitrogen oxide treatment MOO.

The photocatalyst according to the invention can also be used as a filter in order to filter biological agents, such as bacteria, viruses or any other similar compound in a liquid or gas phase. This filtration activity is advantageously accompanied by a photocatalytic activity. The cellular foams according to the invention only partially retain these small objects, but their filtering effect is sufficient in order to lead to an increase in the residence time so that the photocatalytic reaction is more effective. In the case of biological agents, the photocatalytic activity leads to cell death: such a filter at least partially retains the biological agents and releases inactivated biological agents. As an example, such a reactor can be installed very simply at the inlet of air conditioning or air intake ducts of buildings or vehicles. It can also be used to purify gaseous or liquid effluents.

f) Use for biological decontamination

The photocatalyst according to the invention can be used to inactivate or degrade biological agents. We already know bacteria filters based on PU foam (see the article “Potential of Silver Nanoparticle-Coated Polyurethane Foam as an Antibacterial Water Filter” by P. Jain and T. Pradeep, published in the journal Biotechnology and Bioengineering, vol. 90(1), April 2005, p. 59-62). But this does not relate to a catalytic process, because the foam is covered with silver nanoparticles, of which the bactericidal effect is already known.

According to the invention, a photocatalytic method is used to destroy biological agents, which can also be viruses, bacteria, bacterial spores, allergens, fungal spores contained in gaseous or liquid fluids. The advantage of this photocatalytic filter is its low head losses, even for high thicknesses (on the order of one dozen to one hundred centimeters). This enables fluids to be treated with high flow rates (or linear speeds), while ensuring a filtration activity and a photocatalytic activity in the volume. However, most known photocatalytic media have serious limitations. As an example, two-dimensional filtration media, such as felts, papers and woven fabrics do not enable deep penetration of the material retained by the filter in the filtration medium, and cannot be used in the presence of aggressive media. They can also be limited in terms of the volume of the flow to be treated, in particular when they are used in a leaching bed mode in order to limit light penetration problems.

According to the invention, a photocatalytic process is used to destroy biological agents that can also be viruses, bacteria, bacterial spores, allergens and fungal spores.

### g) Advantages of the Invention

The use of three-dimensional cellular foams as a photocatalyst support enables a certain number of limitations encountered to be overcome for most existing substrates or photocatalytic media, namely:

(i) use in a cross-flow with minimal head losses at a high flow rate (or linear speed),

(ii) good light transmission, which can be adjusted by adjusting the size of the cells,

(iii) close contact with the reaction medium (gas or liquid flow) to be treated, due to increased turbulence in contact with the three-dimensional foam,

(iv) use of a three-dimensional medium enables an increased contact distance with the reaction medium when working in a cross-flow (for example, approximately perpendicular to the cross-section of the foam), while in a classic tubular reactor in cross-bed mode, and in particular under the conditions of a piston reactor, the contact distance, i.e. the distance over which there can be contact between the flow and the catalytic coating of the reactor, typically corresponds to the length of the reactor,

(v) the coupling of photocatalytic properties of the foam with its filtration properties, in which the latter can be adjusted according to the cell size,

(vi) in general, flexibility in adaptation, modulation and spatial arrangement of these foams, in order to adapt them to the various environments in which they will be used.

The photocatalyst according to the invention can be produced in the form of a regenerable cartridge.

### EXAMPLES OF EMBODIMENTS

These examples are provided as illustrations to enable a person skilled in the art to produce the invention. They specify specific embodiments of the invention and do not limit its scope.

### Example 1

### Optical Transmission of Foams Used for Implementation of the Invention

We prepared foams based on different materials, with an average cell size of 4500 μm. We determined the optical transmission of blocks of various thicknesses with a light transmitted by a diode with a wavelength of 455 nm. To do these measurements, we used a block in the form of a disk that rotated around an axis. The value measured was an average value taken on different orientations of the foam. The results are summarized in the table.

TABLE 1
Polyurethane foam (average cell size: 4500 μm)

| | | | | | | | |
|---|---|---|---|---|---|---|---|
| Thickness [cm] | 0 | 0.43 | 0.96 | 1.46 | 1.75 | 2.26 | 3.25 |
| Transmission [%] | 100 | 45 | 20 | 12 | 9 | 5 | 3 |

PU foam after polymerization, but before pyrolysis
(average cell size: 4500 μm)

| | | | | | | | |
|---|---|---|---|---|---|---|---|
| Thickness [cm] | 0 | 0.61 | 1.13 | 1.72 | 2.36 | 2.96 | 3.5 |
| Transmission [%] | 100 | 47 | 23 | 9 | 7 | 3 | 2 |

Carbon foam (average cell size: 4500 μm)

| | | | | | | | |
|---|---|---|---|---|---|---|---|
| Thickness [cm] | 0 | 0.46 | 0.86 | 1.34 | 1.83 | 2.36 | 2.56 |
| Transmission [%] | 100 | 42 | 22 | 9 | 8 | 4 | 2 |

Carbon foam + TiO₂ (average cell size: 4500 μm)

| | | | | | | | |
|---|---|---|---|---|---|---|---|
| Thickness [cm] | 0 | 0.46 | 0.86 | 1.34 | 1.83 | 2.36 | 2.56 |
| Transmission [%] | 100 | 38 | 24 | 11 | 8 | 4 | 3 |

In another test, we measured the optical transmissions of blocks of a polyurethane foam with a cell size of 4800 μm or 1900 μm for various thicknesses. These results are indicated in table 2.

TABLE 2

| Cell size [μm] | Thickness [m] | Transmittance [%] |
|---|---|---|
| 1900 | 0.005 | 0.2389 |
| 1900 | 0.01 | 0.0571 |
| 1900 | 0.015 | 0.0136 |
| 4800 | 0.015 | 0.2498 |
| 4800 | 0.02 | 0.1573 |
| 4800 | 0.025 | 0.0991 |
| 4800 | 0.035 | 0.0393 |
| 4800 | 0.04 | 0.0247 |

### Example 2

### Head Losses of Foams Used for Implementation of the Invention

We measured the head loss of a dry air flow (volumetric weight: 1.18 kg/m³, kinematic viscosity 1.84×10⁻⁵ Pa·s, temperature 25° C.) in a block of a polyurethane foam with a thickness of 8.00 cm with a cell size of 4800 μm, for various air speeds. These results are summarized in table 3.

TABLE 3

| | Speed [m/s] | | | | | | | | | |
|---|---|---|---|---|---|---|---|---|---|---|
| | 0.60 | 2.07 | 3.50 | 3.32 | 4.42 | 4.96 | 5.93 | 6.18 | 7.11 | 7.69 |
| Head | 0.10 | 0.70 | 1.70 | 2.20 | 3.90 | 6.00 | 8.80 | 10.00 | 13.00 | 15.00 |
| loss | | | | | | | | | | |
| [mBar] | | | | | | | | | | |
| Head | 125 | 875 | 2125 | 2750 | 4875 | 7500 | 11000 | 12500 | 16250 | 18750 |
| loss (*) | | | | | | | | | | |
| [mBar/m] | | | | | | | | | | |

(*) Head loss per thickness of foam passed through by the air flow

### Example 3

### Preparation of a Carbon Foam

A carbon foam was prepared by impregnating a commercial polyurethane (PU) foam with a cell size >4800 μm with a formophenolic resin. This impregnation was followed by drying at room temperature for one night, then baking at 150° C. for 2 hours. The pyrolysis was performed at 700° C. for 2 hours (increase 2° C./rain under an argon flow at 100 mL/min).

In some of these tests, we used PU foams in the form of cylinders. We for example cut cylinders with an external diameter of 4.2 cm. After impregnation with the phenolic resin, the diameter of the cylinder increased to reach 5.0 cm. We then perforated the cylinder to obtain a foam in the form of rings (internal diameter of 3.0 cm). During the pyrolysis treatment, the foam shrank, and the carbon foam ring then had an external diameter of 4.0 cm and an internal diameter of 2.0 cm.

### Example 4

### Deposition of TiO₂

On twelve carbon foam rings (total weight: 11.95 g) prepared according to example 3, we deposited TiO₂ as follows:

We suspended 0.787 g of powder TiO₂ in an ethanol/water solution (50/50 by volume) and subjected this suspension to ultrasound for 4 hours at room temperature (40 mL of solution). After stopping the stirring, we soaked each foam ring in the solution, in a series of 3-4 baths alternated with drying for 30 minutes at room temperature. At the end of this sequence, we performed a final drying in the furnace for 12 hours at 100° C.

In an alternative of this process, we suspended 3 g of TiO₂ in 60 mL of acetone and subjected the suspension very briefly to ultrasound at room temperature. Then we placed the suspension at −4° C. under light mechanical stirring. After stopping the stirring, we soaked each foam ring in the solution, in two successive baths alternated with drying for around 30 minutes at a temperature of 4° C. This alternative involves slower evaporation and leads to a more homogeneous and more stable deposition.

### Example 5

### Preparation of a Passivated PU Foam and Deposition of the Photocatalytically Active Phase

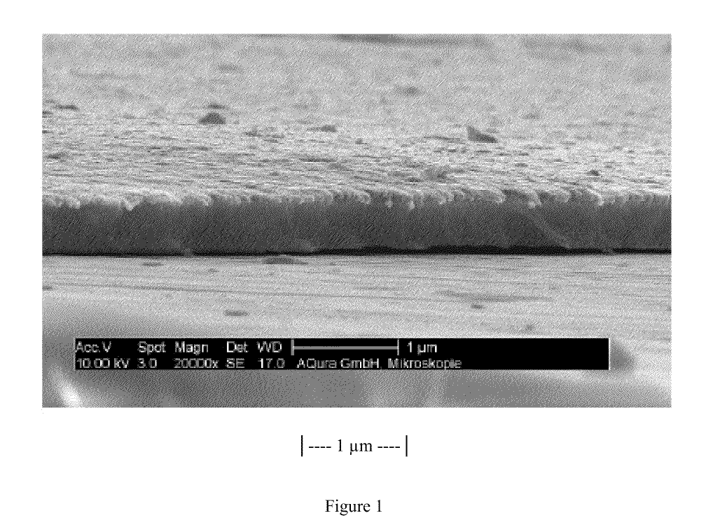

The PU foam (of the same type as described in example 3) was this time directly passivated in order to protect it from photocatalytic degradation, using a plurality of layers formed by a polysiloxane (Sivo 110™, Dynasylan, Evonik). Sivo 110™ is an aqueous silica sol-gel of which some of the silanol (Si—OH) functions have been modified by silane functions (Si—H), and others by reactive epoxy functions, enabling dense film polymerization (see FIG. 1).

We used PU rings prepared as described in example 4. Each ring was immersed in a 50% v/v solution of Sivo 110: Ethanol. We then opened the cells with a brief pass in compressed air, and then performed a polymerization operation for 15 min at 120° C. under air. This immersion-polymerization sequence was repeated three times. Then, we deposited a final layer of this polymer, which should enable the photocatalyst grains to be solidly anchored to the support: after immersion of the ring in a 50% v/v solution of Sivo 110: Ethanol, we allowed the ethanol to evaporate in open air. A viscous film remains on the ring.

On this passivated foam, we then deposited a photocatalyst according to two different embodiments:

(a) “Powder” method: The rings were dipped in an excess of powder of the photocatalyst to be deposited, and subjected to polymerization at 120° C. for 30 minutes in air.

(b) “Aqueous” method: The rings were soaked in an aqueous suspension of the photocatalyst (for example TiO₂), under magnetic stirring.

### Example 6

### Photocatalytic Tests (Oxidation of Methanol into CO₂ and H₂O)

In a tubular reactor (similar to the one described in the publication “Photocatalytic oxidation of butyl acetate on vapor phase on TiO₂, Pt/TiO₂ and WO₃/TiO₂ catalysts” by V. Keller et al., published in Journal of Catalysis, vol. 215, p. 129-138 in 2003), we performed catalytic tests on various foams according to the invention, according to two different modes, referred to here as “Structured reactor” (according to the invention and (by way of comparison) “Classic tubular reactor”. All of the experiments were performed in a dry flow.

For the two modes, the external casing of the photoreactor was a Pyrex tube with a length of 300 mm and a diameter of 42 mm, with the light source located at the centre, namely a black light lamp, providing UV-A light with a power of 8 W (supplier, Philips).

The tests were performed as follows:

The incoming flow was stabilized in flow rate and concentration of methanol on the by-pass. Then, the same flow was switched to the photoreactor, in the dark (UV-A light off). After an adsorption period in the dark (more or less long according to the experimental conditions), during which methanol was adsorbed on the catalyst, the flow returned to its initial value, and the UV-A lamp was then turned on. The photocatalytic performances were then monitored by gas phase microchromatography.

Due to the flows used and the volume of the photoreactor (internal volume of the Pyrex tube from which the volume occupied by the lamp was subtracted), the linear speed of the gas flow was 8 cm/s.

We worked under a dry air flow with a flow rate of 4.32 L/min, using a methanol concentration of 1200 ppm (v/v). To do this, an air flow (flow rate of 40 mL/min) was introduced into a saturator containing liquid methanol (supplier, Carlo Erba, purity >99.9%) at a temperature of 20° C. The air flow was filled with methanol, then diluted in a dry carrier air flow (flow rate of 4.28 L/min). The total flow then had a flow rate of 4.32 L/min.

The comparative tests with a “classic tubular (annular) reactor” were performed as follows.

The desired amount of TiO₂ was suspended in an ethanol/water (50/50 v/v) solution and subjected to ultrasound for 4 hours at room temperature (between 1 g and 4 g in 40 mL of solution). The suspension was then dispersed on the internal surface of the tubular reactor in one step, with a simultaneous drying with a blow dryer. A final drying was performed under air in the furnace at 100° C. for 12 hours. The following results were obtained with a photocatalyst deposited on carbon cellular foam according to the invention:

With the classic tubular reactor (table 4):

TABLE 4

| | Weight [g] | | | | |
|---|---|---|---|---|---|
| | 0.5 | 1 | 2 | 3 | 4 |
| Methanol | 12 | 16 | 23 | 24 | 25 |
| conversion | | | | | |
| [%] | | | | | |

With the structured reactor (table 5):

TABLE 5

| | Weight [g] | | |
|---|---|---|---|
| | 0.8 | 3.5 | 7 |
| Methanol | 26 | 40 | 52 |
| conversion | | | |
| [%] | | | |

### Example 7

### Tests on Microorganisms

We used a tubular photoreactor (300 mm long for 70 mm in internal diameter) made of galvanized steel, which comprised a TiO₂ coating on the internal surface of the tubular casing. This latter casing was prepared as follows:

(i) on the internal surface of the tube, we formed a film with a 50% v/v solution of SIVO 110: Ethanol;

(ii) we then polymerized this film at 180° C. for 15 minutes;

(iii) we repeated step (i);

(iv) we allowed the ethanol to evaporate in open air;

(v) we sprinkled the interior of the tube with an excess of photocatalyst;

(vi) we polymerized it in air at 180° C. for 15 minutes.

In this reactor, we then performed biological inactivation tests on Legionella pneumophila bacteria with different types of foams. The flow rate was 5 m³/h, in “single pass” mode. The lamp was a UV-A 8-watt “black light” lamp (Blacklight Tube, supplied by Philips). For certain tests, we placed a PU foam according to the invention in the reactor, passivated by a SIVO deposition as described in example 6. The results are summarized in table 6. The LRV (Logarithmic Reduction in Viability) parameter indicates the logarithmic reduction in viability, expressed as the logarithm of the ratio between the fraction of microorganisms living upon entering and the fraction of microorganisms living upon exiting the reactor: LRV=log(% living_{entrance}/% livingₑₓᵢₜ). The foam was the same as that in example 5.

TABLE 6

| | | % survival after |
|---|---|---|
| Photoreactor | LRV | one pass |
| Tubular, without foam | 0.4 | 79% |
| Tubular with PU cellular foam | 2.5 | 0.3% |
| with SIVO comprising TiO₂ | | |
| deposited by aqueous method | | |
| Tubular with PU cellular foam | 3.1 | 0.08% |
| with SIVO comprising TiO₂ | | |
| deposited by powder method | | |

### Example 8

### Deposition of Photocatalyst “Layer-by-Layer”

These tests were performed on passivated PU foams and carbon foams.

Each layer was deposited as follows:

The substrate (foam) was soaked in a PEI (polyethyleneimine) solution for 20 minutes (PEI concentration of 8.24 g/L). We then soaked the substrate in 40 mL of a TiO₂ solution P25 (water: ethanol at 50:50 v/v, in an amount of 10 g of P25/L, pH=8) for 20 minutes. This step was followed by two soaking (washing) steps for 10 minutes in distilled water (40 mL). Each step took place under orbital stirring.

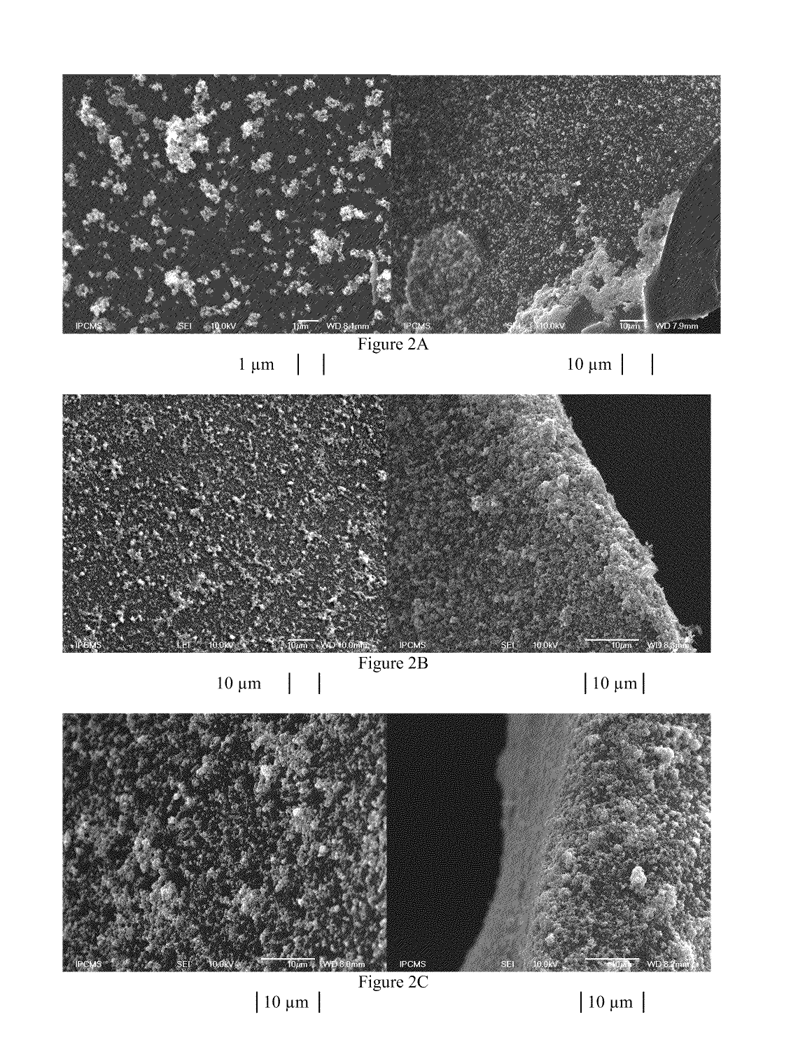

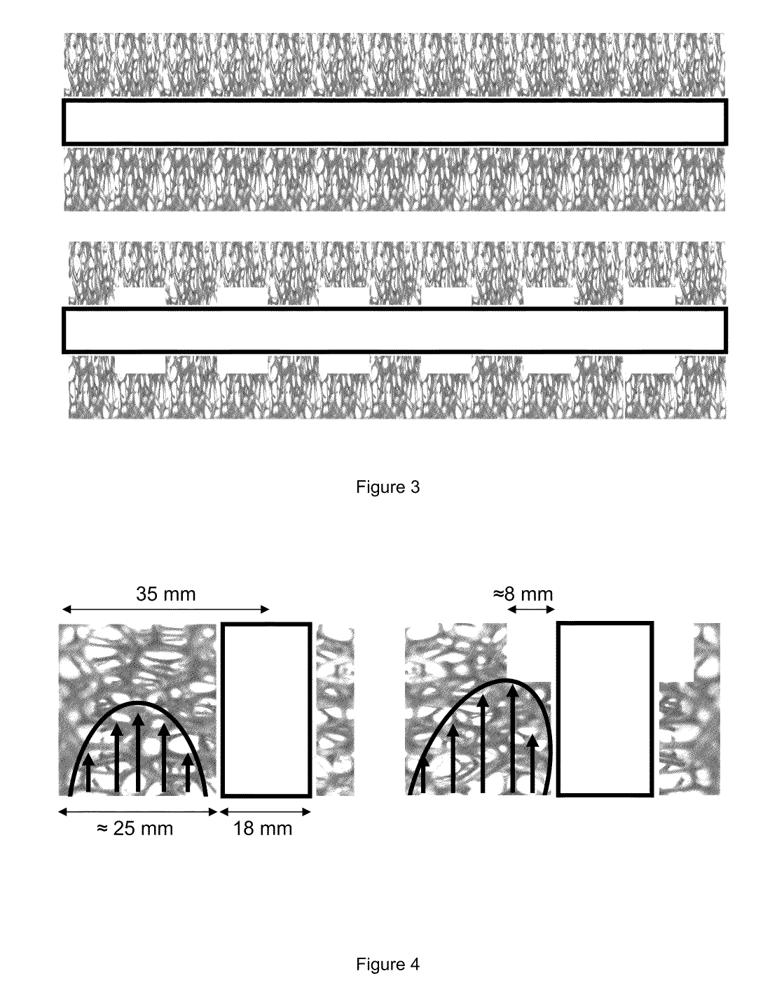

A plurality of layers were then deposited. FIGS. 2A, 2B and 2C each show two micrographs of examples 9A (5 layers), 9B (10 layers) and 9C (15 layers); all of these deposits were done on carbon foam (average cell size: 4800 μm, weight of the part around 1 g).

These foams shoed catalytic performances similar to those tried in example 7.

### Example 9

### Deposition of Photocatalyst by Vapor Phase

We deposited, from a gas phase (CVD method), a titanium precursor on different types of foams. We first provided an ethanol-filled air flow for 1 hour under a vacuum of 60 mbar. We then provided a TTIP vapor-filled air flow for 3 hours under a vacuum of 60 mbar. Finally, we provided a water vapor-filled air flow for 4 hours under a vacuum of 60 mbar.

### Example 10

### Photocatalytic Tests (Oxidation of Methanol into CO₂ and H₂O)

This example is a complement to example 6. The results have been obtained with a photocatalyst deposited on carbon cellular foam according to the invention (“structured reactor”) or with a known tubular foam-free reactor:

With the structured reactor according to the invention (table 7):

TABLE 7

| Dry air | | Residence | Volumetric | | | | |
|---|---|---|---|---|---|---|---|
| flow | Speed | time | concentration | | | | |
| [L/min] | [cm/s] | [s] | of methanol | Weight [g] | 0.8 | 3.5 | 7 |
| 4.32 | 8.2 | 3.18 | 1200 ppm | Methanol | 26 | 40 | 52 |
| | | | | conversion | | | |
| | | | | [%] | | | |

With the classic tubular reactor (table 8):

TABLE 8

| Dry | Volumetric | | | | | | | | | | | | |
|---|---|---|---|---|---|---|---|---|---|---|---|---|---|
| air | concentration | | Residence | | | | | | | | | | |
| flow | of | Speed | time | Weight | | | | | | | | | |
| [L/min] | methanol | [cm/s] | [s] | [g] | 0 | 0.21 | 0.38 | 0.76 | 1.53 | 2 | 2.3 | 3 | 4 |
| 4.32 | 1200 ppm | 8.2 | 3.18 | Methanol | 0 | 7.5 | 14.6 | 24 | 23 | 23 | 23 | 24 | 25 |
| | | | | conversion | | | | | | | | | |
| | | | | [%] | | | | | | | | | |

With the Quartzel® tubular reactor: conversion of 27%

With the “Ahlstrom” tubular reactor: conversion of 19%

In the case of the “Ahlstrom® tubular reactor” test mode, an Ahlstrom® photocatalytic paper (reference 1048) sold by the Ahlstrom company was placed in a circular manner on the internal wall of the tube. The dimensions of the paper were: L×1=260 mm×126 mm.

In the case of the “Quartzel® tubular reactor” test mode, a Quartzel® photocatalytic felt sold by the Saint-Gobain company was placed so as to surround the central lamp and fill the available space in the reactor. The dimensions of the felt were: L×1=260 mm×126 mm, i.e. a total Quartzel® surface of 32,760 mm².

### Example 11

### Photocatalytic Tests (Oxidation of Methanol into CO₂ and H₂O)

This example is a variant of example 6. We worked under a dry air flow with a flow rate ranging from 4.32 L/min to 21.7 L/min using a methanol concentration ranging from 10 ppm to 420 ppm (volumetric). To do this, an adequate dry air flow was sent into a saturator containing liquid methanol (supplier Carlo Erba, purity >99.9%) at a temperature of 20° C. The air flow was filled with methanol, then diluted in a dry carrier air flow so as to obtain the desired total flow with the desired methanol content.

The following results (table 9) were obtained by placing two reactors as described above in parallel (the percentage values express the methanol conversion yield):

TABLE 9

| | | Volumetric | | | |
|---|---|---|---|---|---|
| | | concentration of | | | |
| | | methanol [ppm] | | | |
| | | 420 | 210 | 45 | 10 |
| Flow rate 4.3 L/min | PU foam | 96% | 97% | | |
| Speed/reactor = 4 cm/s | Quartzel ® | 86% | 85% | | |
| Residence time = 6.4 s | Classic | 40% | 52% | | |
| | tubular | | | | |
| Flow rate 11.4 L/min | PU foam | | 88% | 100% | |
| Speed/reactor = | Quartzel ® | | 67% | 72% | |
| 11 cm/s | Classic | | 18% | 21% | |
| Residence time = 2.4 s | tubular | | | | |
| Flow rate 21.7 L/min | PU foam | | 57% | 88% | 100% |
| Speed/reactor = | Quartzel ® | | 47% | 47% | 40% |
| 20.5 cm/s | Classic | | <1% | 1% | 2% |
| Residence time = 1.3 s | tubular | | | | |

The dimensions of the Quartzel® photocatalytic felt used for these tests corresponded to a TiO₂ content of 5.1 g inside the two reactors.

In the case of PU cellular foams according to the invention loaded with TiO₂, the TiO₂ content was only 2.6 g for the two reactors together.

This example shows in particular that the benefit of using foams increases both with respect to the Quartzel® photocatalytic felt and with respect to the classic tubular reactor, when the flow rate increases (which also corresponds to an increase in speed in m/s).

### Example 12

### Study of the Influence of Cell Size on the Optical Transmission of the Foams Used to Implement the Invention

This example is similar to example 2, but in this case a UV-A lamp with a spectrum entered at a maximum of 385 nm, with a power of 8 W supplied by the Philips company. For each thickness, measurements were obtained for different foam positions.

a) Translucent foams (the light can pass through the cells and through the walls of the foam itself): the results are summarized in table 10.

TABLE 10
Polyurethane foam (cell size greater than 4800 μm)
Foam ref.: Bulpren ™ S 32720

| | | | | | |
|---|---|---|---|---|---|
| Thickness [cm] | 0 | 1 | 2 | 1.46 | 3 |
| Transmission | 100 | 42.8 | 15.8 | 8.0 | 5.0 |
| [%] | | | | | |

This data can be indicated by:
Transmission = exp(−thickness/1.106)
The coefficient characterizes the foam transmission
efficacy

Polyurethane foam (average cell size: 2800 μm,
diameter 2300-3300 μm)
Foam ref.: Bulpren ™ S 28280

| | | | | | |
|---|---|---|---|---|---|
| Thickness [cm] | 0 | 1 | 2 | 3 | 4 |
| Transmission | 100 | 37.5 | 15.2 | 7.0 | 4.1% |
| [%] | | | | | |

This data can be indicated by:
Transmission = exp(−thickness/0.977)

The effect of the cell size is fairly moderate because the light can pass through the bridges of the translucent foam.

b) Non-translucent foams (light can pass only through the cells): the results are summarized in table 11:

TABLE 11
Polyurethane foam (cell size greater than 4500 μm)
Foam ref.: Bulpren ™ S 32520

| | | | | | |
|---|---|---|---|---|---|
| Thickness [cm] | 0 | 1 | 2 | 3 | 4 |
| Transmission | 100 | 32.7 | 11.5 | 5.9 | 3.6 |
| [%] | | | | | |

This data can be indicated by:
Transmission = exp(−thickness/0.8444)

Polyurethane foam (average cell size: 4500 μm,
diameter 3800-5200 μm)
Foam ref.: Bulpren ™ S 32450

| | | | | | |
|---|---|---|---|---|---|
| Thickness [cm] | 0 | 0.61 | 1.13 | 1.72 | 2.36 |
| Transmission | 100 | 24.1 | 7.0 | 3.8 | 3.1 |
| [%] | | | | | |

This data can be indicated by:
Transmission = exp(−thickness/0.658)

It can clearly be seen that the influence of the cell size on the light transmission is greater in the case of non-translucent foams. Once a foam is covered with a photocatalyst (for example TiO₂), it becomes non-translucent.

### Example 13

### Study of the Influence of Cell Size on Photocatalytic Performance

The same reactor as in example 6 was used. This example shows the importance of the cell size, with cells of medium size (case 4) demonstrating performances superior to those obtained with foams having smaller cell sizes (case 1) or larger cell sizes (cases 2 and 3). This example also shows the superiority of the foams tested in example 4, with an intermediate cell size, with respect to the other examples.

The following results (see table 12) were obtained with a photocatalyst deposited on a PU cellular foam according to the invention.

Dry air flow rate: 0.4 L/min−Speed=0.8 cm/s−Residence time=34 s

Volumetric concentration of methanol: 1200 ppm

TiO₂: P25 of Degussa (Evonik)

TABLE 12

| | | | | | | |
|---|---|---|---|---|---|---|
| Case 1 | Cell size | TiO₂ weight [g] | 0 | 0.08 | 0.16 | 0.27 |
| | 2300-3300 μm | cm of foams | 0 | 2 | 4 | 6 |
| | (average 2800 μm) | Methanol | 0 | 8 | 16 | 22 |
| | Foam ref.: | conversion [%] | | | | |
| | Bulpren ™ S 28280 | | | | | |
| Case 2 | Cell size | TiO₂ weight [g] | 0 | 0.39 | 0.62 | |
| | Greater than or | cm of foams | 0 | 4 | 6 | |
| | equal to 4500 μm | Methanol | 0 | 28 | 38 | |
| | Foam ref.: | conversion [%] | | | | |
| | Bulpren ™ S 32520 | | | | | |
| Case 3 | Cell size | TiO₂ weight [g] | 0 | 0.10 | 0.18 | 0.28 |
| | Greater than or | cm of foams | 0 | 2 | 4 | 6 |
| | equal to 4800 μm | Methanol | 0 | 20 | 35 | 54 |
| | Foam ref.: | conversion [%] | | | | |
| | Bulpren ™ S 32720 | | | | | |
| Case 4 | Cell size | TiO₂ weight [g] | 0 | 0.09 | 0.18 | 0.28 |
| | 3800-5200 microns | cm of foams | 0 | 2 | 4 | 6 |
| | (average 4500 | Methanol | 0 | 31 | 44 | 65 |
| | microns) | conversion [%] | | | | |
| | Foam ref.: | | | | | |
| | Bulpren ™ S 32450 | | | | | |

### Example 14

### Deposition of a Passivation Layer on a Polyurethane Cellular Foam

4.11 g de AlO(OH) (trade name Disperal®, product Code 535100, supplier Akzo) were dispersed in 50 mL of an aqueous solution. The alumina layer was obtained by immersion of the PU foam in the aqueous Disperal® solution, followed by a low-temperature heat treatment, for example 15 minutes at 200° C., or even 15 minutes at 100° C.

After the final alumina layer was formed, the deposition of TiO₂ P25, dispersed in an aqueous or ethanol/water solution was performed:
Preparation of a suspension of TiO₂ in H₂O at 100 g/L;
Vigorous agitation for at least one night (15 hours);
Soaking of the passivated foam;
Removal of the impregnated foam;
Light passage of compressed air to clear any cell blockages.
Drying at room temperature.

### Example 15

### Preparation of a Passivated PU Foam and Deposition of the Photocatalytically Active Phase

In this example, we will schematically describe the steps of the process.

A) Deposition and polymerization of an inorganic polysiloxane film
Preparation of the polysiloxane bath by magnetic agitation for about 10 minutes;
Stop agitation;
Soaking of the macroscopic PU foam in a polysiloxane bath, taking care to remove all air bubbles in the volume (shake vigorously) so as to impregnate the entire volume;
Removal of the impregnated foam;
Primary draining by agitating the top of the bath (collection of liquid);
Secondary draining by deposition of impregnated foams on absorbent paper;
Passage of compressed air to clear any cell blockages and effectively drain for several seconds;
Dry in the oven at 150° C. for 20 minutes (foams deposited on aluminum paper sheet to prevent attachment);
Removal of foams from the oven;
Rest at room temperature for 5 minutes;
Repetition of operation to add a second polysiloxane layer.

B) Deposition of the photocatalyst
Preparation of a suspension of TiO₂ in H₂O at 100 g/L;
Vigorous agitation for at least one night (15 hours);
Soaking of the foam prepared in step A;
Removal of the impregnated foam;
Light passage of compressed air to clear any cell blockages;
Drying at room temperature.

1. Photocatalyst comprising a cellular foam selected from carbon foam and the foam of a carbon material, such as a polymer, and a photocatalyticaily active phase, deposited directly on said cellular foam or on an intermediate phase deposited on said cellular foam, characterized in that the average size of the cells is between 2500 μm and 5000 μm, and preferably between 3000 μm and 5000 μm.

2. Photocatalyst according to claim 1, characterized in that said cellular foam has a density of between 0.1 g/cm³ and 0.4 g/cm³.

3. Photocatalyst according to claim 1 or 2, characterized in that it has, in the visible spectrum between 400 and 700 nm, an optical transmission of at least 10% for a foam with a thickness of 1.5 cm.

4. Photocatalyst according to any one of claims 1 to 3, characterized in that it comprises a passivation layer capable of protecting said cellular foam from the reaction medium of the photocatalytic reactor and from degradation of the substrate by direct action of the activated photocatalyst.

5. Photocatalyst according to any one of claims 1 to 4, characterized in that said foam comprises nanotubes or nanofibers, which constitute, or which support as an intermediate phase, a photocatalytically active phase, in which said nanotubes or nanofibers are preferably selected from TiO₂ and titanates.

6. Photocatalyst according to any one of claims 1 to 5, characterized in that said photocatalytically active phase is selected from the group consisting of:
metal oxides such as WO₃, ZnO, TiO₂ and SnO₂; optionally doped or on which charge transfer elements have been grafted,
metal sulfides or selenides, optionally doped, such as CdS, CdSe, ZnS, ZnSe and WS₂;
type III-V semiconductors, optionally doped, such as GaAs and GaP;
SiC.

7. Process for producing a photocatalyst based on carbon cellular foam according to any one of claims 1 to 6, including the following steps:
(a) a carbonizable cellular polymer foam preform is provided;
(b) said preform is impregnated with a carbonizable polymer resin;
(c) said polymer resin is polymerized;
(d) said preform and said polymerized resin are transformed into carbon;
(e) a photocatalytically active phase is deposited, preferably selected from the semiconductors in the group consisting of:
metal oxides such as WO₃, ZnO, TiO₂ and SnO₂,
metal sulfides or selenides, such as CdS, CdSe, ZnS, ZnSe and WS₂,
type III-V semiconductors, optionally doped, such as GaAs and GaP,
SiC.

8. Process according to claim 7, in which, between steps (d) and (e), nanotubes or nanofibers, preferably of TiO₂ are deposited, in which the deposition of said TiO₂ nanofibers or nanotubes can optionally replace the deposition of the photocatalyst in step (e).

9. Process according to claim 7 or 8, in which the photocatalytically active phase is deposited by one of the following techniques:
from a suspension of crystallized particles, preferably applied by soaking and impregnation, aerosol or droplets,
by sol-gel synthesis,
by deposition from a vapor phase,
by deposition of successive polyelectrolyte layers,
by the Langmuir-Blodgett technique.

10. Photoreactor comprising at least one photocatalyst according to any one of claims 1 to 6.

11. Photoreactor according to claim 10, characterized in that it includes a liquid- and gas-tight casing element, at least one part of a photocatalyst according to any one of claims 1 to 6 located inside said casing element, and at least one light radiation source.

12. Photoreactor according to claim 11, characterized in that said at least one photocatalyst part has a ring shape.

13. Photoreactor according to claim 12, characterized in that:
(a) it includes a plurality of N annular parts of a photocatalyst according to any one of parts 1 to 6,
(b) said light radiation is introduced in the internal diameter of said annular parts,
(c) said annular parts have an internal diameter that is alternatively different, so that all of the even-numbered parts have the same internal diameter dₗ, and all of the odd-numbered parts have the same internal diameter d₂.

14. Photoreactor according to claim 13, characterized in that said annular parts are separated by an empty space or a part that is optically transparent to at least a portion of said light radiation used.

15. Use of a photocatalyst according to any one of claims 1 to 6 or of the photoreactor according to any one of claims 10 to 14 in order to catalyze liquid phase chemical reactions.

16. Use of a photocatalyst according to any one of claims 1 to 6 or of the photoreactor according to any one of claims 10 to 14 in order to inactivate or degrade biological agents.
